(19) United States
(12) Patent Application Publication
(10) Pub. No.: US 2017/0010606 A1
(43) Pub. Date: Jan. 12, 2017

(54) METHOD FOR DETERMINING VARIABLES OF A PRODUCTION-DATA CAPTURE OR MACHINE-DATA CAPTURE PROCESS

(71) Applicant: BERNECKER + RAINER INDUSTRIE-ELEKTRONIK Ges.m.b.H., Eggelsberg (AT)

(72) Inventor: Franz EDER, Handenberg (AT)

(73) Assignee: BERNECKER + RAINER INDUSTRIE-ELEKTRONIK Ges.m.b.H., Eggelsberg (AT)

(21) Appl. No.: 15/116,394

(22) PCT Filed: Jan. 26, 2015
(86) PCT No.: PCT/EP2015/051451

§ 371 Date: Aug. 3, 2016

(30) Foreign Application Priority Data
Feb. 4, 2014 (AT) A50080/2014

(51) Int. Cl. G05B 23/02

(52) U.S. Cl. CPC G05B 23/0221

(57) ABSTRACT

In order to capture production data capture process or machine data of a cyclically operating production machine in a simple manner, it is provided that a measurement signal (S₁, S₂, S₃, . . . , Sₙ) is used in order to determine the working cycle of the consumer unit (2₁, 2₂, 2₃, . . . , 2ₙ) and the measurement signal (S₁, S₂, S₃, . . . , Sₙ) is simultaneously mathematically analyzed in order to determine a working cycle of the consumer (2₁, 2₂, 2₃, . . . , 2ₙ) and with the determined cycle duration of the working cycle to determine at least one variable of the production data capture process or machine data capture process.

The present invention relates to a method for determining variables of a production data capture process or a machine data capture process of a cyclically operating consumer unit of a production process, wherein at least a measurement signal which characterizes the energy consumption of the consumer unit is captured and the energy consumption of the consumer unit is determined therefrom.

In production facilities a multiplicity of machines or electrical consumer units are used for manufacturing different products. In this case many machines are often operated in parallel for manufacturing similar parts. In this case, however, the machinery is generally not homogeneous, but uses different machine makes or machine types. As an example of this mention may be made of the manufacture of injection molded parts, where injection molded parts are manufactured simultaneously on many injection molding machines.

For the present invention, however, it is not crucial whether different or similar production machines produce different or similar parts, and it is also not crucial whether the machinery used for this is homogeneous or not. The method can likewise be used in production systems with identical machines, such as for any number of different workpieces.

In modern production facilities in the context of the production data capture and machine data capture a series of different variables of production machines or production processes are captured, recorded, evaluated and displayed. As examples of such variables of the production machine or of the production process for the production data capture process and machine data capture process, mention may be made here of production parts, production speed, malfunctions, shutdown periods, maintenance breaks, machine states, etc. For this purpose, on the production machine different sensors which capture different measurement variables on the production machine and supply them to an evaluating unit are provided, or required measurement variables are retrieved by communication with the machine control system. Then the required variables for the production data capture process and machine data capture process are determined from the measurement variables of the sensors or from the machine control system. However, the disadvantage of this is that the most varied sensors are required which must be installed and wired or that a costly communication with the machine control system is necessary, which increases the cost of the production data capture process and machine data capture process or influences the production system.

In addition, energy management systems are often also used in production facilities, in order to capture and evaluate the energy consumption of production machines or electrical consumer units, for example in order to optimize the energy consumption by means of a parameter change of the production machine or the consumer unit. However, this also requires expensive communication with the machine control system in order to be able to directly influence the production machine. An example of energy optimization on a machine with a cyclically running process, such as for example an injection molding machine, is described in EP 1 346 812 B1. Here the cycle is divided into a plurality of sub-cycles and it is attempted to optimize the energy consumption of individual sub-cycles by variation of the machine parameters. Different sensors, such as for example a current or voltage sensor, are used for capturing the energy consumption. Variables of the production machine or of the production process, in addition to the energy consumption or related variables, are not captured systematically here.

It is an object of the present invention to capture and to make available operating data or machine data of a cyclically operating production machine in a simple manner.

This object is achieved according to the invention in that the at least one measurement signal is simultaneously mathematically analyzed in order to determine a working cycle of the consumer unit and in order to determine at least one variable of the production data capture process or machine data capture process with the determined cycle duration of the working cycle. The measurement signal which characterizes the energy consumption is simultaneously evaluated by known mathematical methods, in order to determine the working cycle of the production process. The working cycle or the cycle duration of the working cycle is then the basis for determination of an abundance of variables of the production data capture process and machine data capture process, such as for example production part, production speed, production quality, production consistency, malfunctions, shutdown periods, maintenance breaks, machine states, malfunctions, temporal changes in the production process, etc. Thus measurement variables which are captured anyway are used simultaneously in order to reach conclusions as to variables of the production data or machine data capture process. The capture of further measurement variables or a costly machine communication is superfluous as a result.

Possible mathematical methods for determining the working cycle are an autocorrelation analysis of the measurement signal, the search for a recurring dominant frequency in the frequency spectrum of the measurement signal or the search for a characteristic recurring signal pattern in the measurement signal, although there are a number of other mathematical methods.

Advantageously the clock pulse of the consumer unit is determined from the determined working cycle, and from this the production part and/or the production speed of the consumer unit can be determined as variable of the production data capture process and machine data capture process.

The signal pattern of the measurement signal is advantageously integrated over the working cycle, from which a break, malfunction or switching off of the consumer unit can be determined as variable of the production data capture process and machine data capture process.

The signal pattern of the measurement signal is advantageously integrated over the working cycle, from which changes in the production process or of the consumer unit can be determined from a comparison of the integrals over successive working cycles or with a predetermined threshold value.

The signal pattern of the measurement signal is advantageously integrated over the working cycle and the process consistency or the production quality are determined from the variance of the integral of the measurement signal of successive working cycles as variable of the production data and machine data capture process.

A specific production process is advantageously determined by comparison or autocorrelation of the measurement signal in a working cycle with a stored sample signal pattern.

Furthermore, the energy consumption of a plurality of consumer units can also be determined advantageously and from this a total energy consumption over time can be determined, and the total energy consumption can be optimized in order to smooth energy consumption peaks.

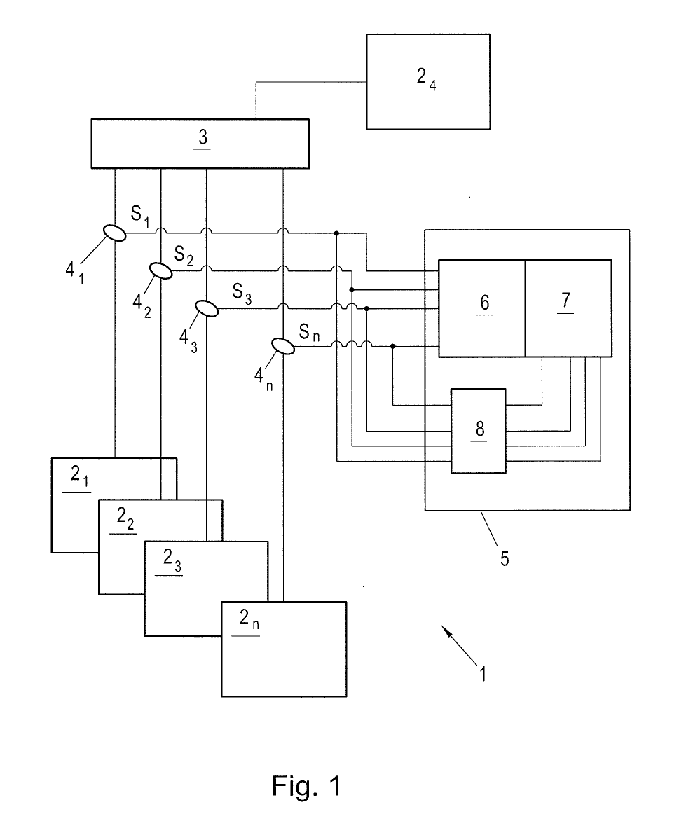

The present invention is explained in greater detail below with reference to FIG. 1, which shows an advantageous embodiment of the invention by way of example, schematically and without limitation. In the drawings:

FIG. 1 shows a system layout for the production data capture process and machine data capture process according to the invention.

The production facility 1 shown schematically in FIG. 1 comprises a number of cyclically operating consumer units 2₁, 2₂, 2₃, . . . , 2ₙ, which obtain the required energy for their operation from an energy distribution system 3. A consumer unit may be a production machine or an individual drive of a production machine, e.g. an electric motor, a hydraulic or pneumatic cylinder. “Cyclically operating” means that a working process is repeated cyclically in a working cycle. Cyclical working processes frequently take place at production machines. An injection molding machine, a deep drawing machine, an automatic press, a cyclical recipe execution, may be mentioned as examples of a cyclical working process. The energy can be made available for example in the form of electrical, hydraulic or pneumatic energy. In order to be able to measure the energy consumption of consumer units 2₁, 2₂, 2₃, . . . , 2ₙ, measurement sensors 4₁, 4₂, 4₃, . . . , 4ₙ are provided, for example current sensors, voltage sensors, power sensors, pressure sensors, flow sensors, etc., which supply their measurement signal S₁, S₂, S₃, Sₙ to an energy evaluation unit 6 of an evaluation unit 5. However, measurement signals S₁, S₂, S₃, . . . , Sₙ do not have to be captured from all consumer units 2₁, 2₂, 2₃, . . . , 2ₙ, but for the invention it is sufficient to capture at least one measurement signal S₁, S₂, S₃, . . . , Sₙ from at least one consumer unit 2₁, 2₂, 2₃, . . . , 2ₙ. In the energy evaluation unit 6 the energy consumption of the individual consumer units 2₁, 2₂, 2₃, . . . , 2ₙ can be captured, evaluated, displayed and, if required, optimized.

The measurement signals S₁, S₂, S₃, . . . , Sₙ of the measurement sensors 4₁, 4₂, 4₃, . . . , 4ₙ are simultaneously evaluated mathematically in a signal analysis unit 8, in order to derive therefrom relevant variables of the consumer units 2₁, 2₂, 2₃, . . . , 2ₙ or of the production process for a production data capture process or machine data capture process 7.

The working cycle of a consumer unit 2₁, 2₂, 2₃, . . . , 2ₙ is determined for example by an autocorrelation analysis of a measurement signal S₁, S₂, S₃, . . . , Sₙ associated with this consumer unit 2₁, 2₂, 2₃, . . . , 2ₙ. Alternatively the working cycle could also be found by searching for a recurring dominant frequency in the frequency spectrum of an associated measurement signal S₁, S₂, S₃, . . . , Sₙ. The measurement signal S₁, S₂, S₃, . . . , Sₙ could also be analyzed with intelligent filters or sought according to characteristic recurring signal patterns, in order to recognize the working cycle. There are an abundance of known mathematical methods in order to extract from a measurement signal S₁, S₂, S₃, . . . , Sₙ, comprising at least two working cycles, a repeating working cycle which is contained therein. Since these methods are all sufficiently known, a precise description of these methods is omitted here.

For an automatic reliable evaluation of the measurement signals S₁, S₂, S₃, . . . , Sₙ a possible solution is autocorrelation analysis. For this purpose the temporal progression of a measurement signal S1, S2, S3, . . . , Sₙ of a consumer unit 2₁, 2₂, 2₃, . . . , 2ₙ is measured and autocorrelated over at least two working cycles. For example, for an electrical consumer unit, such as an electric motor, the electrical current or the electrical power as measurement signal can be continuously measured and can be continuously autocorrelated in the signal analysis unit 8.

The clock pulse of the respective consumer unit 2₁, 2₂, 2₃, . . . , 2ₙ can be deduced from the determined working cycle, and from this in turn variables of the production data capture process and machine data capture process such as number of produced parts and/or production speed can be derived.

By means of the cycle duration which is now known, the temporal progression of the measurement signal S₁, S₂, S₃, . . . , Sₙ within a working cycle can be observed or mathematically evaluated, and from this further relevant variables of the consumer units 2₁, 2₂, 2₃, . . . , 2ₙ or of the production process for a production data capture or machine data capture process 7 can be derived.

For example, the measurement signal S₁, S₂, S₃, . . . , Sₙ can be integrated over the cycle duration, and from this a break, malfunction or disconnection of the consumer unit 2₁, 2₂, 2₃, . . . , 2ₙ can be deduced. If the integral is zero, a shutdown can be deduced. If the integral deviates from an expected value or value range, a malfunction can be deduced. By comparison of the integral over successive cycle durations conclusions can be drawn about changes in the production process or on the consumer unit, such as for example wear, contamination, damage, etc. Non-normal states of a consumer unit S₁, S₂, S₃, . . . , Sₙ can, for example, also be recognized by comparison of a respective measurement signal 2₁, 2₂, 2₃, . . . , 2ₙ with a specified threshold value.

A conclusion may be drawn for example as to the process consistency or also the production quality from the variance of the integral of a measurement signal S₁, S₂, S₃, . . . , Sₙ of successive working cycles. The greater the variance, the lower the process consistency is, which can also reduce the production quality.

The signal pattern of a measurement signal S₁, S₂, S₃, . . . , Sₙ is in many cases also representative of a specific workpiece or a currently produced product. Thus by the comparison or the autocorrelation of the measurement signal S₁, S₂, S₃, . . . , Sₙ of a working cycle with stored sample signal patterns, a conclusion can be drawn as to a specific production process, for example the production of a specific product or recipe. For example, the tool equipped in this way can be automatically recognized in injection molding or on presses.

On the basis of the recognized working cycles and the synchronized capture of the signal patterns of the different consumer units, the total energy consumption of the production system over time can be optimized, as for example working cycles are shifted relative to one another in terms of time in order to smooth energy consumption peaks. If a direct intervention in the production machine is to be avoided, at least the potential for optimization of the total energy consumption can be determined and demonstrated. In this case optimizations in the production system can also be proposed.

1. A method for determining variables of a production data capture process or machine data capture process of a cyclically operating consumer unit (2₁, 2₂, 2₃, . . . , 2ₙ) of a production process, wherein at least one measurement signal (S₁, S₂, S₃, . . . , Sₙ) of the consumer unit (2₁, 2₂, 2₃, . . . , 2ₙ) which characterizes the energy consumption is captured and the energy consumption of the consumer unit (2₁, 2₂, 2₃, . . . , 2ₙ) is determined therefrom, characterized in that the at least one measurement signal (S₁, S₂, S₃, . . . , Sₙ) is simultaneously mathematically analyzed in order to determine a working cycle of the consumer unit (2₁, 2₂, 2₃, . . . , 2ₙ) and to determine at least one variable of the production data capture process or machine data capture process out of the determined cycle duration of the working cycle.

2. The method according to claim 1, characterized in that the working cycle is determined by an autocorrelation analysis of the measurement signal (S₁, S₂, S₃, . . . , Sₙ).

3. The method according to claim 1, characterized in that the working cycle is determined by searching of a recurring dominant frequency in the frequency spectrum of the measurement signal (S₁, S₂, S₃, . . . , Sₙ).

4. The method according to claim 1, characterized in that the working cycle is determined by searching for a characteristic recurring signal pattern in the measurement signal (S₁, S₂, S₃, . . . , Sₙ).

5. The method according to claim 1, characterized in that the clock pulse of the consumer unit (2₁, 2₂, 2₃, . . . , 2ₙ) is determined from the determined working cycle, and from this the number of produced parts and/or the production speed of the consumer unit (2₁, 2₂, 2₃, . . . , 2ₙ) can be determined as variable of the production data capture process and machine data capture process.

6. The method according to claim 1, characterized in that the signal pattern of the measurement signal (S₁, S₂, S₃, . . . , Sₙ) is integrated over the working cycle, from which a break, malfunction or switching off of the consumer unit (2₁, 2₂, 2₃, . . . 2ₙ) is determined as variable of the production data capture process and machine data capture process.

7. The method according to claim 1, characterized in that the signal pattern of the measurement signal (S₁, S₂, S₃, . . . , Sₙ) is integrated over the working cycle, from which changes in the production process or of the consumer unit (2₁, 2₂, 2₃, . . . , 2ₙ) can be determined from a comparison of the integrals over successive working cycles or with a predetermined threshold value.

8. The method according to claim 1, characterized in that the signal pattern of the measurement signal (S₁, S₂, S₃, . . . , Sₙ) is integrated over the working cycle, and the process consistency or the production quality are determined from the variance of the integral of the measurement signal (S1, S2, S3, . . . , Sn) of successive working cycles as a variable of the production data capture process and machine data capture process.

9. The method according to claim 1, characterized in that a specific production process is determined by comparison or autocorrelation of the measurement signal (S₁, S₂, S₃, . . . , Sₙ) of a working cycle with a stored sample signal pattern.

10. The method according to claim 1, characterized in that the energy consumption of a plurality of consumer units (2₁, 2₂, 2₃, . . . , 2ₙ) is determined and from this a total energy consumption over time is determined, and the total energy consumption is optimized in order to smooth energy consumption peaks.
